(19) United States
(12) Patent Application Publication
(10) Pub. No.: US 2026/0349233 A1
(43) Pub. Date: Nov. 5, 2026

(54) MICROSCOPE OBJECTIVE, IN PARTICULAR FOR A DEVICE FOR DETERMINING THE POSITION OF STRUCTURES ON A MASK FOR MICROLITHOGRAPHY

(71) Applicant: Carl Zeiss SMT GmbH, Oberkochen (DE)

(72) Inventor: Alexander Epple, Aalen (DE)

(21) Appl. No.: 19/646,833

(22) Filed: Apr. 14, 2026

(30) Foreign Application Priority Data
Apr. 28, 2025 (DE) 102025116223.9

(51) Int. Cl. G02B 21/00; G02B 1/02; G02B 21/04; G02B 21/16; G02B 21/33; G02B 27/00

(52) U.S. Cl. CPC G02B 21/0016; G02B 1/02; G02B 21/04; G02B 21/16; G02B 21/33; G02B 27/0037

(57) ABSTRACT

The invention relates to a microscope objective, in particular for a device for determining the position of structures on a mask for microlithography. According to one aspect, a microscope objective according to the invention comprises a first number of converging lenses made of a first material and a second number of diverging lenses made of a second material, with the microscope objective being designed for an operating wavelength below 190 nm and with the following relationship

$$A = \frac{NA}{\frac{{v}_{1}}{{v}_{2}} - 1} > 2.5$$

applying, where NA denotes the object-side numerical aperture of the microscope objective, v₁ denotes the Abbe number of the first material and v₂ denotes the Abbe number of the second material.

### CROSS-REFERENCE TO RELATED APPLICATION

This application claims priority of German Application No. 10 2025 116 223.9, filed on Apr. 28, 2025. The entire content of this application is herein incorporated by reference.

### TECHNICAL FIELD

The invention relates to a microscope objective, in particular for a device for determining the position of structures on a mask for microlithography.

### BACKGROUND

Microlithography is used for producing microstructured components, such as for example, integrated circuits or liquid crystal displays (LCDs). The microlithography process is carried out in a so-called projection exposure apparatus comprising an illumination device and a projection lens. The image of a mask (=reticle) illuminated by use of the illumination device is in this case projected by use of the projection lens onto a substrate (e.g., a silicon wafer) coated with a light-sensitive layer (photoresist) and arranged in the image plane of the projection lens, in order to transfer the mask structure to the light-sensitive coating of the substrate.

Mask inspection systems are used to inspect the mask used in the microlithography process or to characterize the structures present on the mask. This characterization is performed both with regard to existing deviations of the respective structure on the mask from the target position specified by the design (so-called placement error or “registration error,” referring to: “registration”) and with regard to the minimum (critical) line width of the structures (CD=“critical dimension”). The mask is imaged onto a detector using a high-resolution microscope objective with high magnification (e.g., 300-500×).

Given the high accuracy requirements applicable to the microlithography process, the provision of a microscope objective of sufficient resolution in the context of characterizing the structures present on the mask is in practice an increasingly demanding challenge.

In microlithographic optical systems (projection exposure apparatuses or mask inspection systems) designed for operation in the DUV range (e.g., at operating wavelengths below 400 nm, in particular below 250 nm), use is typically made of laser light sources in the form of excimer lasers, e.g., krypton fluoride excimer lasers at an operating wavelength of approximately 248 nm or argon fluoride excimer lasers at an operating wavelength of approximately 193 nm. In principle, a significant increase in resolution is conceivable by significantly reducing the operating wavelength and/or by significantly increasing the numerical aperture (e.g., by providing an immersion system).

In practice, however, problems arise here on account of the limitations imposed with a shorter operating wavelength with regard to the optical materials available in the optical system with sufficient transmission, where especially in the spectral range below 190 nm, quartz glass (SiO₂)—which is customary at the aforementioned operating wavelengths of approximately 248 nm or 193 nm—is no longer usable.

A further challenge in providing microscope objectives for mask characterization arises from the bandwidth of the light source used, since if bandwidth filtering is not available, even values of the bandwidth in the range of a few picometres (pm) necessitate possibly complex correction of chromatic aberrations. However, the realization of concepts commonly used for this purpose, such as the combined use of diverging and converging lenses made of materials with significantly different dispersion, is in turn hampered by the abovementioned restrictions regarding available optical materials in the range of shorter operating wavelengths.

In respect of the prior art, reference is made purely by way of example to DE 39 15 868 C2, WO 2008/019803 A1, US 2009/0034061 A1, U.S. Pat. No. 7,187,503 B2, WO 01/50171 A1, U.S. Pat. No. 6,362,923 B1, U.S. Pat. No. 7,075,721 B2, U.S. Pat. No. 6,757,051 B2, US 2008/0198353 A1, WO 2004/053534 A2, and also the publications: J. Mulkens et al.: “Benefits and limitations of immersion lithography,” J. Microlith., Microfab., Microsyst., Vol. 3 No. 1, 1-11 (2004) [DOI: 10.1117/1.1636768] and L. Schupmann, “On short-focal-length medial telescopes,” Zeitschrift für Instrumentenkunde, Vol. XXXIII, pages 308-312 (1913).

### SUMMARY

The problem addressed by the present invention is that of providing a microscope objective, in particular for a device for determining the position of structures on a mask for microlithography, which enables a significant increase in resolution while taking into account the above drawbacks.

This problem is solved in accordance with the features of the independent claims.

According to one aspect, the invention relates to a microscope objective, in particular for a device for determining the position of structures on a mask for microlithography, having a first number of converging lenses made of a first material and a second number of diverging lenses made of a second material, with the microscope objective being designed for an operating wavelength below 190 nm and with the following relationship

$$A = \frac{NA}{\frac{{v}_{1}}{{v}_{2}} - 1} > 2.5$$

applying, where NA denotes the object-side numerical aperture of the microscope objective, v₁ denotes the Abbe number of the first material and v₂ denotes the Abbe number of the second material.

Here, the ratio v₁/v₂ contained in the formula above describes the dispersion difference or spectral separation between the two materials. The calculation of the Abbe number is explained in even more detail below in the description of the figures.

In particular, the invention is based on the concept of enabling the increase in optical resolution that is achievable using an operating wavelength below 190 nm in a microscope objective for a microlithographic mask inspection system by accepting an increased complexity of the optical design, with this complexity ultimately being determined by the following parameter

$$A = \frac{NA}{\frac{{v}_{1}}{{v}_{2}} - 1}$$

as explained below.

The starting point in this case is the consideration that the step according to the invention towards operating wavelengths below 190 nm (in particular operating wavelengths below 180 nm and more particularly below 170 nm) is associated with a limitation regarding the materials that are still acceptable for the optical design (i.e., are still sufficiently transmissive for the respective operating wavelength), whereby the longitudinal chromatic aberration correction generally required—specifically when the bandwidth of the light source used is significant—is made more difficult in turn. It should be noted that such a correction of the longitudinal chromatic aberration is mandatory if the bandwidth of the light source has or exceeds a value of a few picometres.

Given a smaller dispersion difference (characterized by the ratio v₁/v₂ contained in the formula above) between two materials (so-called crown material with comparatively low dispersion and so-called flint material with comparatively higher dispersion), the combination of a first number of converging lenses with a comparatively low dispersion (i.e., a larger Abbe number v₁) with a second number of diverging lenses with a comparatively larger dispersion (i.e., a smaller Abbe number v₂) in an alternating sequence, known per se for such a correction of the longitudinal chromatic aberration, leads to a greater number of lenses or lens pairs that are needed for a sufficient correction of the longitudinal chromatic aberration overall, with the consequence that the installation space required and the material outlay and costs also increase in addition to the complexity of the optical system.

However, according to the invention, the aforementioned disadvantages are deliberately accepted in order—in return—to obtain the increase in the optical resolving power, which accompanies the transition to shorter operating wavelengths, and the increased accuracy of the mask characterization caused thereby.

Attention is drawn to the fact that systems in which—in addition to the first number of converging lenses made of the first material and the second number of diverging lenses made of the second material—provision is also made for one (or more) converging lenses made of the second material (or made of a further material) and/or also one (or more) diverging lenses made of the first material (or a further material) should also be considered to be encompassed by the invention.

According to an embodiment, the following applies to the parameter defined above: A>2.8, in particular A>3.0 and more particularly A>3.2.

According to an embodiment, the microscope objective is designed for an operating wavelength below 180 nm, in particular below 170 nm and more particularly below 160 nm.

According to an embodiment, the first number of converging lenses and the second number of diverging lenses are both greater than seven, in particular greater than eight. This takes account of the requirement for a comparatively large number of required converging lenses and diverging lenses, which—as yet to be explained in detail below—is a consequence of the invention.

According to an embodiment, the following relationship applies: N>λ/0.22, in particular N>λ/0.20 and more particularly N>λ/0.18, where N is the total number of lenses of the microscope objective. In this case, on optionally present plane-parallel plate or end plate is not regarded as a lens, i.e., is not included in the total number N.

According to an embodiment, the object-side numerical aperture (NA) of the microscope objective is at least 0.6, in particular at least 0.85, more particularly at least 0.9, more particularly at least 1.0 and more particularly at least 1.1.

According to an embodiment, the second material is selected from the group containing lithium barium fluoride (LiBaF₃), lithium fluoride (LiF) and sodium chloride (NaCl).

According to an embodiment, the first material is calcium fluoride (CaF₂).

According to an embodiment, the converging lenses and the diverging lenses form an alternating arrangement. In this context, the term “alternating arrangement” should also be considered to comprise arrangements in which two or more converging lenses or two or more diverging lenses follow one another (in other words, a respective converging lens or diverging lens is optionally divided into multiple lenses within the arrangement).

According to an embodiment, the microscope objective comprises an aperture stop arranged in a stop plane, with the ratio B=d₁/d₂ for this stop plane being greater than four, in particular greater than five, where d₂ denotes the distance between the stop plane and the object plane and d₁ denotes the overall length of the microscope objective from the object plane to the last lens vertex. This ratio ensures that the object space of the microscope objective is imaged telecentrically, which in turn represents an essential prerequisite for the registration process.

According to an embodiment, an image contrast obtained when operating the microscope objective using light with a bandwidth greater than 2 pm, in particular greater than 5 pm, more particularly greater than 10 pm and more particularly greater than 20 pm is reduced by no more than 10% in comparison with the use of light from an ideal monochromatic light source.

This is based on the consideration that a high-contrast image can be generated as a matter of principle when a non-achromatized microscope objective with a (hypothetically) monochromatic light source is used, but once a light source has a certain bandwidth of, e.g., 10 pm (FWHM=“full-width at half maximum”), the nominal image is increasingly overlaid with defocused images produced by the secondary wavelengths if the longitudinal chromatic aberration is not corrected. This can significantly reduce the contrast of the image representations. What can be achieved as a result of the longitudinal chromatic aberration correction according to the invention is that the imaging contrast does not decrease or only decreases slightly in the case of a finite bandwidth.

The concept according to the invention of providing a high-aperture microscope objective while correcting chromatic aberrations at the same time is not limited to the aforementioned combined use of converging lenses made of the first material and diverging lenses made of the second material, but can also be implemented by the use of a mirror, i.e., by the realization of a catadioptric system, in embodiments.

According to the invention, disadvantages accompanying the requirement of the additional mirror and the attendant comparatively large installation space with likewise relatively high complexity and the obscuration caused by the mirror are likewise accepted here. In return, however, it is advantageously possible to dispense with the second material (required in the embodiments described above on the basis of FIG. 1A to FIG. 4) (i.e., it is possible to realize a “one-material system”). Moreover, according to the invention, this disadvantage is also accepted deliberately in this case in order to obtain the increase in the optical resolving power which accompanies the transition to shorter operating wavelengths even if use is made of a relatively broadband light source with a simultaneous correction of chromatic aberrations.

The invention therefore further also relates to a microscope objective, in particular for a device for determining the position of structures on a mask for microlithography,
wherein the microscope objective is designed for an operating wavelength (λ) below 190 nm,
wherein the object-side numerical aperture (NA) of the microscope objective is at least 0.6,
wherein the microscope objective comprises a mirror (M1) for at least partial correction of chromatic aberrations, and
wherein an image contrast obtained when operating the microscope objective using light with a bandwidth greater than 2 pm is reduced by no more than 10% in comparison with the use of light from an ideal monochromatic light source.

According to an embodiment, an image contrast obtained when operating the microscope objective using light with a bandwidth greater than 5 pm, in particular greater than 10 pm and more particularly greater than 20 pm is reduced by no more than 10% in comparison with the use of light from an ideal monochromatic light source.

According to an embodiment, the microscope objective has an immersion medium between the last lens on the object plane side and the object plane, said immersion medium having a refractive index of at least 1.3 at the operating wavelength (A).

The immersion medium can be in particular perfluoropolyether (=PFPE). In this context, reference is made to the following publication: J. Mulkens et al.: “Benefits and limitations of immersion lithography”, J Microlith., Microfab., Microsyst., Vol. 3 No. 1, 1-11 (2004) [DOI: 10.1117/1.1636768].

According to an embodiment, the microscope objective comprises a last lens on the object plane side made of a material which has a refractive index of at least 1.8, in particular at least 2.0, at the operating wavelength.

According to an embodiment, between a last optical surface of the microscope objective on the object plane side and the object plane there is a distance of less than λ, in particular less than λ/2, more particularly less than λ/5.

According to an embodiment, the microscope objective comprises a diffractive optical element (DOE) for at least partial correction of chromatic aberrations, in particular of the longitudinal chromatic aberration.

The provision of a diffractive optical element (DOE) for at least partial correction of chromatic aberrations with the aim of obtaining the increase in optical resolving power achieved by the transition to shorter operating wavelengths even when a relatively broadband light source is used is also advantageous independently of the aforementioned combined use of converging lenses made of the first material and diverging lenses made of the second material or the use of the mirror or the realization of a catadioptric system.

The invention therefore further also relates to a microscope objective, in particular for a device for determining the position of structures on a mask for microlithography,
wherein the microscope objective is designed for an operating wavelength (A) below 190 nm,
wherein the object-side numerical aperture (NA) of the microscope objective is at least 0.6,
wherein the microscope objective comprises a diffractive optical element (DOE) for at least partial correction of chromatic aberrations, and
wherein an image contrast obtained when operating the microscope objective using light with a bandwidth greater than 2 pm is reduced by no more than 10% in comparison with the use of light from an ideal monochromatic light source.

According to an embodiment, an image contrast obtained when operating the microscope objective using light with a bandwidth greater than 5 pm, in particular greater than 10 pm and more particularly greater than 20 pm is reduced by no more than 10% in comparison with the use of light from an ideal monochromatic light source.

According to an embodiment, the microscope objective comprises exclusively a single optical material.

The invention furthermore also relates to a device for determining the position of structures on a mask for microlithography, wherein the device comprises a microscope objective having the features described above.

Further configurations of the invention can be gathered from the description and the dependent claims.

The invention will be explained in more detail below on the basis of exemplary embodiments illustrated in the appended figures.

### BRIEF DESCRIPTION OF DRAWINGS

In the figures:

FIG. 1A shows a schematic illustration of a dioptric microscope objective in accordance with a first embodiment of the invention;

FIG. 1B shows a schematic illustration for explaining the possible use of the microscope objective from FIG. 1A in combination with a tube system;

FIGS. 2-5 show schematic illustrations of further embodiments of a dioptric microscope objective according to the invention;

FIGS. 6-7 show schematic illustrations of embodiments of a catadioptric microscope objective according to the invention; and

FIG. 8 shows a schematic illustration of a conventional microscope objective designed for an operating wavelength of approximately 193 nm.

### DETAILED DESCRIPTION

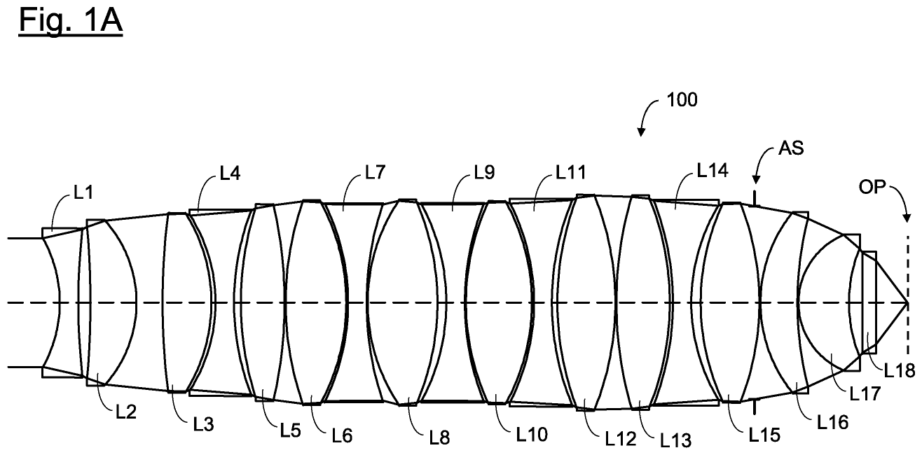

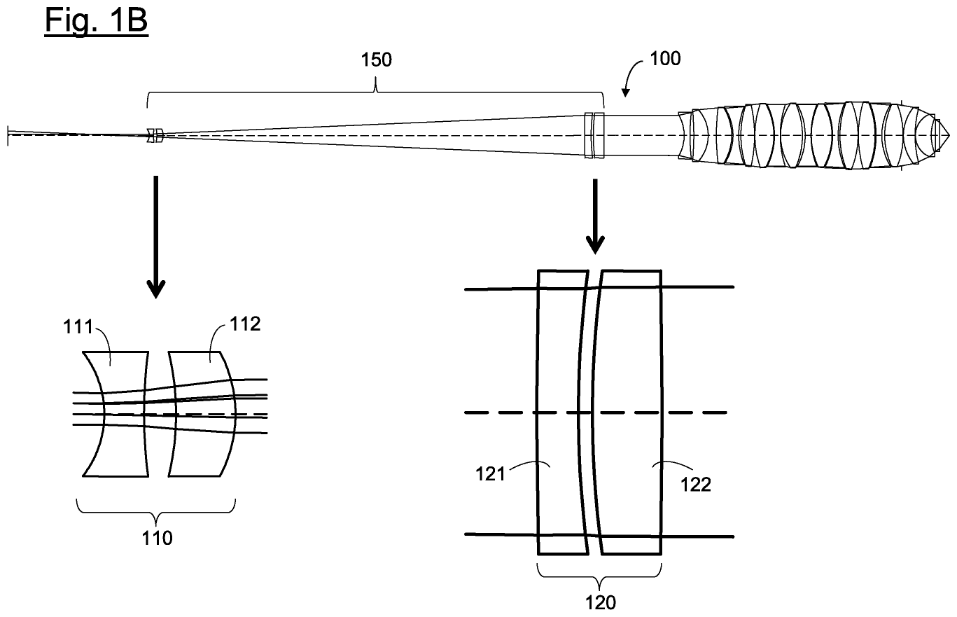

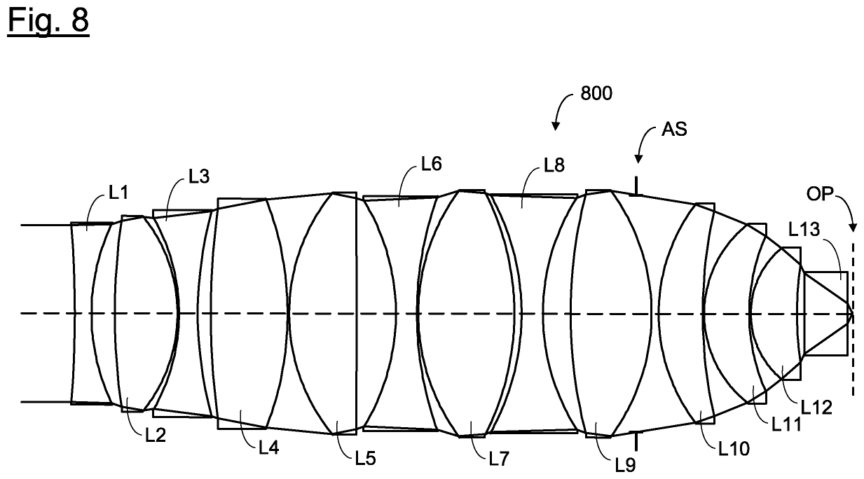

Various embodiments of a microscope objective according to the invention are described below with reference to the schematic (sectional) views in FIG. 1A to FIG. 7, with a conventional microscope objective designed for an operating wavelength of approximately 193 nm also being described on the basis of FIG. 8 for comparison purposes.

In relation to this detailed description of the exemplary embodiments in FIG. 1A to FIG. 7, attention should be drawn to the fact that during the intended use of the respective systems for high-aperture imaging of a lithography mask (reticle), this mask or the corresponding object plane of the projection lens is situated at the right-hand end of the illustration, and the actual imaging by the relevant system is implemented from right to left. However, irrespective thereof, the optical elements or lenses in FIGS. 1A to 7 and in the associated Tables 1 to 7, which contain the specific design data, are numbered for a beam path assumed—purely for the purpose of the description—as running in the reverse direction (i.e., running from left to right).

What the embodiments described on the basis of FIG. 1A to FIG. 7 have in common is that comparatively high-aperture designs designed for an operating wavelength below 190 nm (in particular approximately 157 nm) are provided, in the case of which a sufficient correction of chromatic aberrations is obtained despite allowing for a relatively broadband light source (e.g., with a bandwidth of several picometres). For this chromatic correction—required as a result of the possible broadband nature of the light source—the invention inter alia accepts the disadvantage of increased complexity of design, with this increased complexity in turn being caused by the transition according to the invention to comparatively short operating wavelengths. However, this complexity is accepted deliberately in order to obtain the greater optical resolution, which accompanies the comparatively short operating wavelength and high numerical aperture, in return.

Thus, while the embodiments described below have the achievement of a chromatic correction in common, the latter can be achieved in different ways depending on the embodiment.

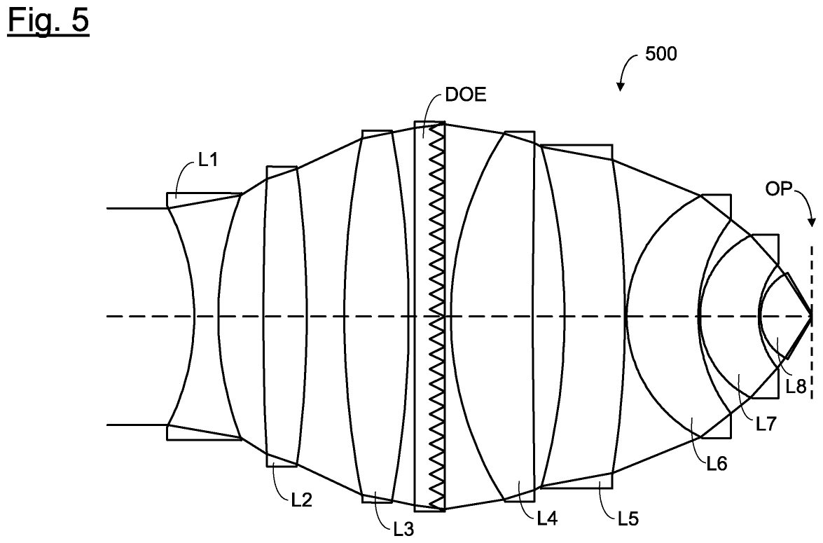

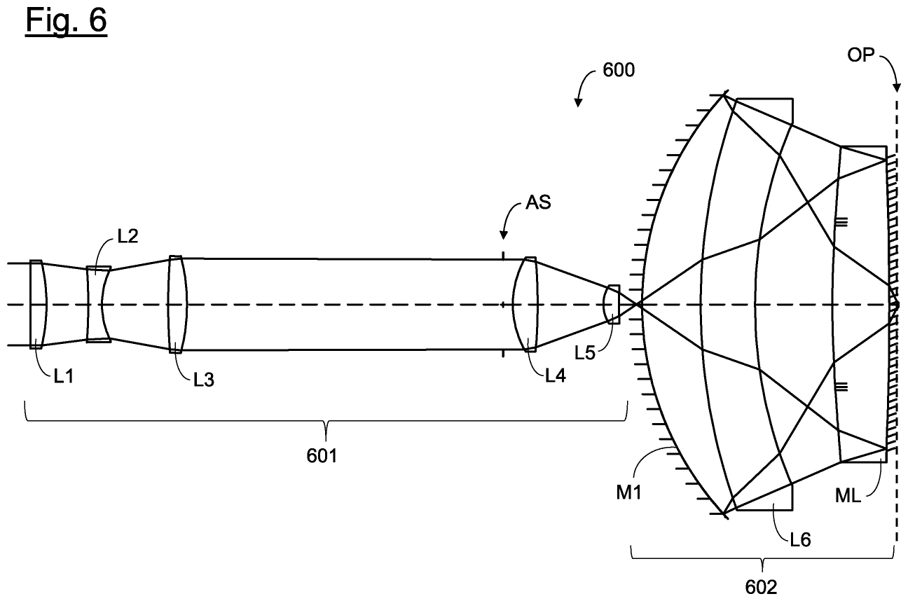

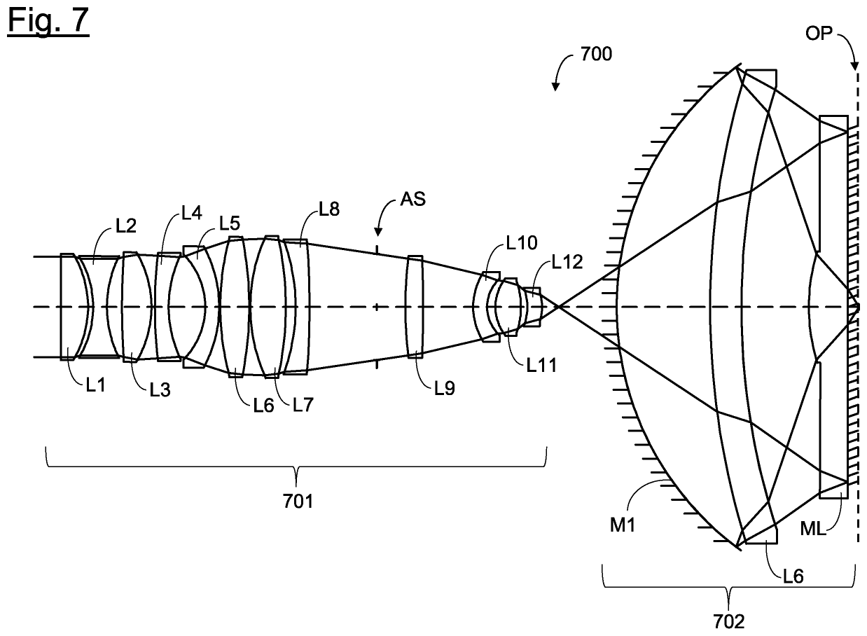

Specifically, the subsequent description of the figures comprises embodiments in which said chromatic correction is implemented by (a) the provision of a comparatively large number of converging lenses and diverging lenses made of different materials in alternating succession in a purely refractive, i.e., dioptric, design (cf. FIG. 1A to FIG. 4), (b) the use of a diffractive optical element (DOE) for chromatic correction in a likewise purely refractive, i.e., dioptric, design (cf. FIG. 5) or (c) the use of at least one mirror in the catadioptric design (cf. FIG. 6 and FIG. 7).

In all of the aforementioned embodiments, the increased complexity of the optical setup (which is caused in each case, as mentioned above, by (a) a comparatively large number of lenses, (b) the use of a diffractive optical element or (c) the use of the mirror) takes account of the circumstances that the selection of available, sufficiently transmissive optical materials is greatly limited due to the transition to shorter operating wavelengths according to the invention, (with quartz (SiO₂), which is conventional at operating wavelengths of, e.g., 248 nm or 193 nm, in particular no longer being available).

To the extent that, with reference initially to the embodiments of FIG. 1 to FIG. 4, the chromatic correction required on account of the possibly broadband light source is now realized using the concept—known per se—of combining converging and diverging lenses made of materials with different dispersions, the aforementioned circumstance of the non-availability of quartz (SiO₂) at wavelengths below 190 nm specifically means that, e.g., the low-dispersion (crown) material in the form of calcium fluoride (CaF₂), which can still be used as the optical material of the converging lenses, must be combined with converging lenses made a different optical (flint) material with a comparatively higher dispersion.

In this respect, a material found to be suitable within the scope of the present invention is lithium barium fluoride (LiBaF₃) in particular; however, due to a relatively small difference in dispersion compared with calcium fluoride (CaF₂), it is inevitably necessary to accept in turn a greater required number of lens pairs made of converging and diverging lenses for the chromatic correction. The increased number of necessary lens pairs of diverging lenses made of lithium barium fluoride (LiBaF₃) and converging lenses made of calcium fluoride (CaF₂) takes account of the circumstances that as a consequence of the smaller difference in dispersion of these materials (for instance in comparison with the material combination of quartz (SiO₂)/calcium fluoride (CaF₂) in the wavelength range around 193 nm), the chromatic correction (achromatization) obtained by a respective crown-flint lens pair is less effective.

What the embodiments described initially on the basis of FIG. 1A to FIG. 4 have in common is that the following relationship

$$\frac{NA}{\frac{{v}_{1}}{{v}_{2}} - 1} > 2.5 \qquad ( 1 )$$

applies, where NA denotes the object-side numerical aperture of the microscope objective, v₁ denotes the Abbe number of the first material and v₂ denotes the Abbe number of the second material.

The term

$$\frac{NA}{\frac{{v}_{1}}{{v}_{2}} - 1}$$

(denoted as “parameter A” in the following) is representative of the difficulty of achieving a correction of chromatic aberrations using two different materials (having different dispersions). For optimal correction of chromatic aberrations using two different materials with different dispersions, it is generally advantageous if the Abbe numbers v₁ and v₂ of these two materials differ as much as possible. Conversely, the correction of chromatic aberrations using two different materials (having different dispersions) becomes comparatively more difficult if the Abbe numbers of these two materials differ only slightly from one another. Furthermore, the parameter A (or the difficulty of correcting chromatic aberrations) is also proportional to the numerical aperture NA. In equation (1), the parameter A assumes a very large value if v₁ is close to v₂. In the limiting case of identical dispersion, the parameter A would become infinitely large, and correction of chromatic aberrations would no longer be possible. By contrast, if v₁ is significantly larger than v₂, a comparatively small value for A is obtained; for example, the parameter A takes on a value on the order of the numerical aperture NA when v₁ is twice as large as v₂ (so that, in a system with a typical example value of NA=0.9, the parameter would amount to A=0.9 as well). As described further below, the present application provides embodiments or designs for which the parameter A assumes a value greater than 2.5 (for example, A=3.08 for the embodiment of FIG. 1A). By way of comparison, the conventional system according to FIG. 8A, which is designed for an operating wavelength of approximately 193 nm and includes lenses made of calcium fluoride (CaF₂) and quartz glass (SiO₂), achieves a value of A=2.09.

In this case, the Abbe number v (at an operating wavelength of 157 nm given in the exemplary embodiments) is calculated according to, e.g.,

$$v = \frac{{n}_{157.0} - 1}{{n}_{156.9} - {n}_{157.1}} \qquad ( 2 )$$

where the values of the refractive indices for the different wavelengths are given in the tables relating to the respective exemplary embodiments.

The invention is not limited to an operating wavelength of 157 nm; rather, a microscope objective according to the invention can also be designed for another operating wavelength (e.g., smaller than 157 nm). In general, the Abbe number can be calculated for a particular operating wavelength as follows:

$$v = \frac{{n}_{{λ}_{0}} - 1}{{n}_{{λ}_{0} - \frac{Δ λ}{2} -} {n}_{{λ}_{0} + \frac{Δ λ}{2}}} \qquad ( 3 )$$

In equation (3), λ₀ denotes the operating wavelength, whereas AA corresponds to a bandwith to be achieved or to a typical wavelength range for which the system has been achromatized.

As an example, Δλ may amount to 0.2 nm in line with equation (2). It should however be noted that, while the Abbe number itself depends according to equation (3) on the specific values for λ₀ and Δλ, the value of the ratio

$$\frac{{v}_{1}}{{v}_{2}}$$

present in formular (1) is practically independent of the specific values for λ₀ and Δλ.

FIG. 1A shows in the lens sectional view a first exemplary embodiment of a microscope objective 100 with a purely refractive, dioptric setup, which has an object-side numerical aperture of NA=0.80. The associated design data are given at the end of the description of the figures, in Table 1. The microscope objective 100 according to FIG. 1A comprises a total of six diverging lenses (L1, L4, L7, L9, L11 and L14) made of lithium barium fluoride (LiBaF₃) and eleven converging lenses (L2, L3, L5, L6, L8, L10, L12, L13, L15, L16 and L17) made of calcium fluoride (CaF₂), which form an alternating arrangement. In this case, the term “alternating arrangement” should also be considered as encompassing arrangements like in FIG. 1, in which two or more converging lenses or two or more diverging lenses follow one another and hence form a converging or diverging lens group in each case.

“L18” denotes a plane-parallel end plate made of calcium fluoride (CaF₂), which may serve to seal the optionally gas-filled objective from the surroundings and which may also serve for measurement purposes, e.g., a determination of an optical distance between the plane underside and the substantially plane reticle. Depending on the specific use scenario, the end plate may also be omitted by simple adaptations to the optical design.

“AS” denotes an aperture stop which is situated quite close to the object plane OP (or reticle plane), situated to the right in the illustration, in order to ensure telecentric imaging conditions. What preferably holds true for the position of the corresponding stop plane of this aperture stop AS is that the ratio B=d₁/d₂ is greater than four, in particular greater than five, where d₂ denotes the distance of the stop plane from the object plane OP, and d₁ denotes the overall length of the microscope objective 100 from the first lens vertex of L1 to the object plane.

The microscope objective 100 according to FIG. 1A comprises seventeen lenses with an object plane-side numerical aperture NA of 0.8 and a dispersion difference

$$\frac{{v}_{1}}{{v}_{2}} = 1.26 .$$

Hence the parameter

$$A = \frac{NA}{\frac{{v}_{1}}{{v}_{2}} - 1}$$

has a value of 3.08. The parameter B has a value of 5.54.

A further feature of the microscope objective 100 in FIG. 1A is the comparatively large “working distance” between the object plane OP and the last optical element on the object plane side, which is 4.4 mm in accordance with Table 1; this may also allow an arrangement of a pellicle (used for protecting the mask) in this region.

FIG. 1B shows—proceeding from the microscope objective 100 described above with reference to FIG. 1A—an overall system in which the microscope objective 100 is used in conjunction with a tube system 150. The tube system 150 comprises (starting from the left once again merely for the purposes of the description) a diverging first lens group 110 made of two lenses 111, 112 and a collimating and converging lens group 120 made of two lenses 121, 122. During practical operation (i.e., use for mask characterization), the tube system 150 has the effect that the imaging “at infinity” performed by the microscope objective 100 with a high numerical aperture NA on the object plane side (i.e., with high resolution) initially in collimation is imaged onto a detector “at a finite distance” with a comparatively high magnification (300× in the exemplary embodiment). The tube system 150 is designed in such a way here that it is corrected with respect to the longitudinal chromatic aberration and just compensates for the transverse chromatic aberration of the microscope objective 100.

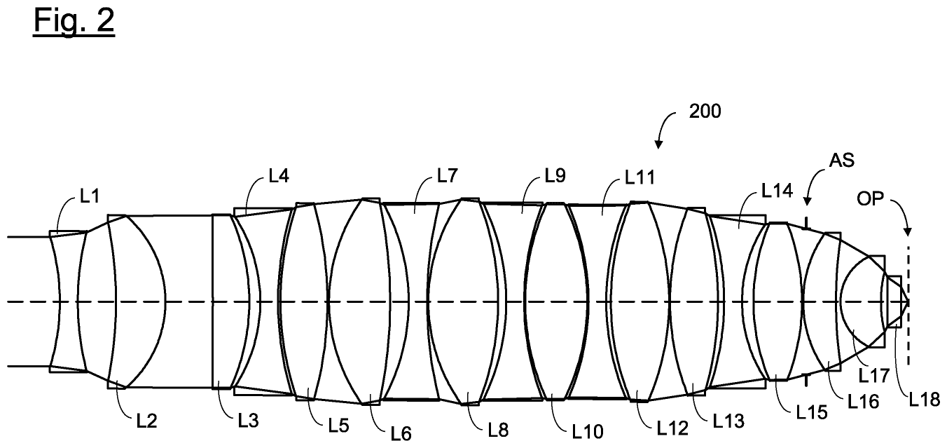

Although for the sake of simplicity for each of the embodiments described below with reference to FIG. 2 to FIG. 7, the illustration of such a tube system is dispensed with, this system can be realized straightforwardly in an analogous manner in each case substantially analogously to FIG. 1B for each of the corresponding microscope objectives.

FIG. 8 shows, for comparison in lens section, a conventional microscope objective 800 with likewise a purely refractive, dioptric setup, which is designed for an operating wavelength of approximately 193 nm and in which—in contrast to the embodiments according to the invention in FIG. 1A to FIG. 7—quartz (SiO₂) can consequently be used as an optical material. The microscope objective 800 according to FIG. 8 comprises a total of four diverging lenses (L1, L3, L6 and L8) made of quartz (SiO₂) and eight converging lenses (L2, L4, L5, L7, L9, L10, L11 and L12) made of calcium fluoride (CaF₂). “L13” denotes a plane parallel end plate (which is optional depending on the specific use scenario).

The microscope objective 800 according to FIG. 8 accordingly comprises a total of twelve lenses with an object plane-side numerical aperture NA of 0.9 and a dispersion difference

$$\frac{{v}_{1}}{{v}_{2}} = 1.43 .$$

Hence, the parameter A defined above has a value of 2.09. The parameter B has a value of 3.60.

As a further exemplary embodiment, FIG. 2 shows a microscope objective 200 with a largely analogous setup in comparison with FIG. 1A; here, the (primary) longitudinal chromatic aberration is likewise corrected by the use of six diverging lenses (L1, L4, L7, L9, L11 and L14) made of lithium barium fluoride (LiBaF₃) and eleven converging lenses (L2, L3, L5, L6, L8, L10, L12, L13, L15, L16 and L17) made of calcium fluoride (CaF₂) in alternating arrangement. “L18” denotes a plane parallel end plate made of calcium fluoride (CaF₂)(which is optional depending on the specific use scenario). The associated design data of the microscope objective 200 are given in Table 2.

In particular, the microscope objective 200 differs from the microscope objective 100 in that, in the microscope objective 200, the aforementioned working distance between the closest optical element on the object plane side and the object plane OP has been reduced in order to increase the numerical aperture to a value of NA=0.90. For the dispersion difference,

$$\frac{{v}_{1}}{{v}_{2}} = 1.26$$

also applies here.

In the case of the microscope objective 200 according to FIG. 2, the above-defined parameter A has a value of 3.46. The parameter B has a value of 8.31.

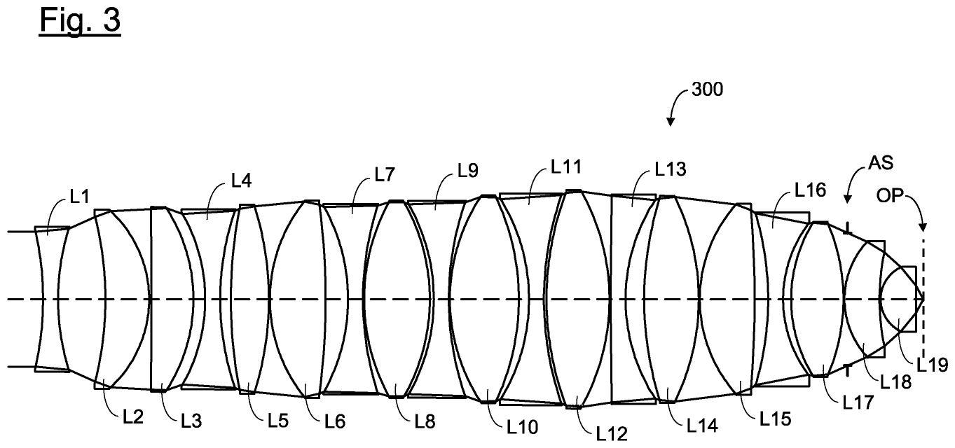

FIG. 3 shows a further exemplary embodiment of a microscope objective 300, in which a further increase in the numerical aperture to a value of NA=1.20 is achieved. This is effected by using an immersion liquid PFPE between the object plane OP and the closest lens L19 on the object plane side. To this end, the closest lens L19 on the object plane side is configured with a plane face on its side facing the object plane OP and in significantly convex fashion on its opposite side. The microscope objective 300 according to FIG. 3 comprises a total of seven diverging lenses (L1, L4, L7, L9, L11, L13 and L16) made of lithium barium fluoride (LiBaF₃) and twelve converging lenses (L2, L3, L5, L6, L8, L10, L12, L14, L15, L17, L18 and L19) made of calcium fluoride (CaF₂), which form an alternating arrangement. The associated design data are given in Table 3.

Optionally, the lens L19, which is closest to the object and a plane face of which is adjacent to the immersion medium, is provided with a suitable coating on said plane face in order to protect the latter from a chemical interaction with the immersion medium.

The microscope objective 300 according to FIG. 3 comprises a total of nineteen lenses with an object plane-side numerical aperture of NA=1.20. For the dispersion difference,

$$\frac{{v}_{1}}{{v}_{2}} = 1.26$$

also applies here. Hence, the parameter A defined above has a value of 4.62. The parameter B has a value of 11.64.

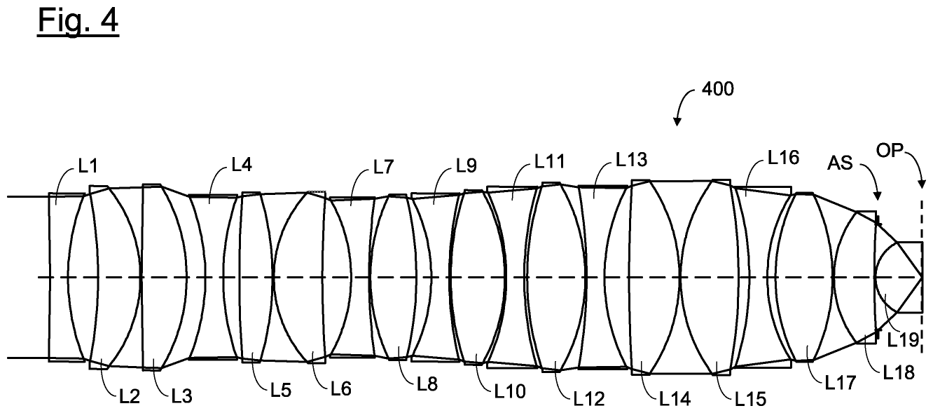

FIG. 4 shows as a further exemplary embodiment a microscope objective 400, in which the numerical aperture is again significantly increased to a value of NA=1.75. According to FIG. 4 and the associated Table 4, this is achieved by using a high-refractive material in the closest lens L19 on the object plane side, in a manner according to the “solid immersion” concept—known per se—in combination with a particularly small working distance. In the exemplary embodiment in FIG. 4, the lens L19 is made of lutetium aluminium garnet (Lu₃Al₅O₁₂, LuAG).

The microscope objective 400 according to FIG. 4 comprises a total of seven diverging lenses (L1, L4, L7, L9, L11, L13 and L16) made of lithium barium fluoride (LiBaF₃) and twelve converging lenses (L2, L3, L5, L6, L8, L10, L12, L14, L15, L17, L18 and L19), with these converging lenses (with the exception of the aforementioned lens L19) being produced from calcium fluoride (CaF₂).

For the dispersion difference,

$$\frac{{v}_{1}}{{v}_{2}} = 1.26$$

also applies here. In the exemplary embodiment of FIG. 4, the above-defined parameter A has a value of 6.73. The parameter B has a value of 19.84.

As a further exemplary embodiment, FIG. 5 shows a projection lens 500 in which—in this respect analogous to FIG. 4—the “solid immersion” concept is likewise realized in order to increase the numerical aperture (here with a value of NA=1.3). The associated design data are given in Table 5A.

In contrast to the embodiments of FIG. 1A to FIG. 4, however, the chromatic correction (i.e., the achromatization) according to FIG. 5 is implemented by the use of a diffractive optical element (DOE). The DOE is situated at a position of the microscope objective 500 which corresponds to the largest lens diameter of the system and comprises a grating structure which is formed on a plane-parallel plate and merely indicated schematically and in much simplified fashion in FIG. 5. The corresponding design data for the diffractive optical element (DOE) are specified in Table 5B. In this case, the following applies to the phase function Φ(r) of the DOE:

$$Φ ( r ) = DOR \cdot \frac{2 π}{λ} ( {C}_{2} {r}^{2} + {C}_{4} {r}^{4} + {C}_{6} {r}^{6} + … )$$

where λ denotes the operating wavelength, DOR denotes the order of diffraction and r denotes the distance from the optical axis of the system. Moreover, in contrast to the embodiments of FIG. 1A to FIG. 4, all lenses L1 to L8 in the microscope objective 500 according to FIG. 5 and the diffractive optical element (DOE) as well are produced from calcium fluoride (CaF₂). Moreover, the microscope objective 500 comprises a significantly smaller number of lenses (owing to dispensing with the concept of combining crown and flint lenses for achromatization purposes).

The lens L8 closest to the object is ground in conical fashion from a geometric point of view such that the small mechanical working distance is only present in the direct vicinity of the actually observed object field. This measure could likewise be performed in the embodiment of FIG. 4.

FIG. 6 and FIG. 7 show further exemplary embodiments of a microscope objective 600 and 700, respectively, in which the chromatic correction or achromatization in each case is achieved by a catadioptric setup, i.e., by using at least one mirror, in contrast to the embodiments described above on the basis of FIG. 1 to FIG. 5. Moreover, in contrast to FIG. 1A to FIG. 4, the use of different optical materials in the respective lenses is dispensed with. Nevertheless, owing to the chromatic correction—explained below—the exemplary embodiments of FIG. 6 and FIG. 7 still enable the use of a comparatively broadband light source without a significant loss of contrast within the scope of imaging.

The associated design data are given in Tables 6A-6B and Table 7. Here, Table 6A specifies the aspherical faces for the microscope objective 600 of FIG. 6, wherein the following applies to the sagittal height p(r) of the aspherical face:

$$p ( r ) = \frac{ρ {r}^{2}}{1 + \sqrt{1 - ( 1 + k ) {( ρ r )}^{2}}} + {\sum }_{i = 2}^{n} {C}_{i - 1} {r}^{2 i}$$

where p denotes the vertex curvature of the face, k denotes the conic constant of the face and r denotes the distance from the optical axis of the system. With reference initially to FIG. 6, a beam enters in collimated fashion from the left-hand end—when viewed again from left to right as described at the outset (i.e., opposite to the direction of light propagation actually present during operation)—wherein an intermediate image is shaped by way of a first dioptric partial system 601 made of five lenses L1-L5.

All lenses L1-L5 in the microscope objective 600 are produced from calcium fluoride (CaF₂). This intermediate image is not chromatically corrected and consequently exhibits significant under-correction in relation to the longitudinal chromatic aberration. Still viewed from left to right, the light passes through a concave mirror M1 in a second catadioptric subsystem 602 through a central bore and subsequently passes through a meniscus-shaped thick lens L6 as a strongly divergent beam. Thereupon, the light is incident on a further lens ML, which is configured to be virtually plane parallel and which is mirror-coated on its back side. This lens ML is also referred to as a Mangin lens and likewise passed through in highly divergent fashion. Following the first reflection, the pencil of light traverses—once again very divergently—the two lenses ML and L6, is reflected by the mirror M1 and is converted into a convergent pencil of rays. Finally, the light traverses the two lenses ML and L6 a third time, this time as a very convergent pencil of light.

It is possible to show that very convergent and very divergent pencils of light in a thick lens without refractive power (e.g., plane-parallel plate) lead to an over-correction of the longitudinal chromatic aberration, which depends on the thickness of the lens, the dispersion of the lens and the divergence angle (i.e., the local numerical aperture). Hence, the light beam is significantly over-corrected during each passage through the glass in the catadioptric part of the design—and this ultimately completely compensates for the under-correction of the dioptric system and consequently leads to a final image that has been corrected in respect of the longitudinal chromatic aberration.

Within the scope of the chromatic correction in the catadioptric design of FIG. 6, the disadvantage that the light must pass centrally through the catadioptric part is accepted. This requires, firstly, the concave mirror M1 to have a central opening and, secondly, the central region of reflective back side of the Mangin lens ML also to be designed as transmissive or be perforated. A pupil obscuration necessarily present as a result is less than 20% in the design of FIG. 6.

Moreover, in the exemplary embodiment of FIG. 6, the transmitting front side of the Mangin lens ML is aspherized (without the invention being restricted thereto), whereby a reduction in the number of dioptric elements or lenses can be achieved.

Attention should be drawn to the fact that the actual system refractive power in the exemplary embodiment of FIG. 6 is provided in chromatically neutral fashion by a concave mirror. Moreover, the last lens of the dioptric first subsystem 601 directly upstream of the intermediate image serves as a field lens. It can be shown that this field lens in the vicinity of a chromatically uncorrected intermediate image may lead to the complete apochromatic correction of the secondary spectrum by way of induced aberrations.

As a further exemplary embodiment, FIG. 7 shows a microscope objective 700 with a catadioptric setup, which is enhanced vis-à-vis the exemplary embodiment of FIG. 6 by the additional use of immersion. The microscope objective 700 comprises a first dioptric subsystem 701 and a second catadioptric subsystem 702—in this respect it is analogous to FIG. 6. The region or working distance between the mirror-coated side of the Mangin lens ML facing the object plane OP and the object plane OP is filled with an immersion liquid (e.g., PFPE) in this case, with the corresponding mirror-coated side being configured as a plane face. On the opposite side of the Mangin lens ML, i.e., the side facing away from the object plane OP, additional refractive power is realized to enable input coupling with a numerical aperture NA greater than 1, and this additional refractive power is achieved by a comparatively small, thin lens that is attached to the optical face of the Mangin lens ML by optical contact bonding. In order to facilitate the process of attaching a comparatively small, thin lens to the optical face of the Mangin lens by optical contact bonding, the optical face of the Mangin lens ML can be configured as a plane face. Since it is no longer the mirror-coated side but the (top) side facing away from the object plane OP that is decisive for determining the obscuration, the diameter of the lens attached by optical contact bonding determines the size of the resultant obscuration. As a consequence, the value of this obscuration here rises to a value of approximately 50% in the pupil diameter.

TABLE 1
(for FIG. 1A)

| EBR/mm | 9 | | | | | | |
|---|---|---|---|---|---|---|---|
| GIH/mm | 0.01 | | | | | | |
| EFL/mm | 11.25 | | | | | | |
| WL/nm | 157.00 | 156.90 | 157.10 | | | | |
| | | | | | | | Semi- |
| Surface | Radius | Thickness | Material | n(157.00) | n(156.90) | n(157.10) | diameter |
| 0 | 0.000000 | Infinite | | | | | |
| 1 | −18.520162 | 2.600085 | LIBAF3 | 1.723779 | 1.724156 | 1.723403 | 9.0 |
| 2 | 91.482636 | 1.703698 | | | | | 10.3 |
| 3 | −116.668699 | 6.437395 | CAF2 | 1.555560 | 1.555790 | 1.555331 | 10.6 |
| 4 | −17.207370 | 3.664039 | | | | | 11.5 |
| 5 | 102.300007 | 6.818085 | CAF2 | 1.555560 | 1.555790 | 1.555331 | 12.4 |
| 6 | −23.546230 | 0.577883 | | | | | 12.5 |
| 7 | −22.875120 | 2.595404 | LIBAF3 | 1.723779 | 1.724156 | 1.723403 | 12.2 |
| 8 | 35.682845 | 0.943619 | | | | | 12.9 |
| 9 | 43.188270 | 6.134473 | CAF2 | 1.555560 | 1.555790 | 1.555331 | 13.2 |
| 10 | −60.668114 | 0.149765 | | | | | 13.7 |
| 11 | 43.171483 | 8.471230 | CAF2 | 1.555560 | 1.555790 | 1.555331 | 14.2 |
| 12 | −29.519201 | 0.261641 | | | | | 14.1 |
| 13 | −31.063896 | 2.586758 | LIBAF3 | 1.723779 | 1.724156 | 1.723403 | 13.8 |
| 14 | 42.755537 | 0.149826 | | | | | 13.7 |
| 15 | 25.679743 | 9.766426 | CAF2 | 1.555560 | 1.555790 | 1.555331 | 14.3 |
| 16 | −35.464190 | 1.238657 | | | | | 14.1 |
| 17 | −29.146777 | 2.591187 | LIBAF3 | 1.723779 | 1.724156 | 1.723403 | 13.7 |
| 18 | 37.432291 | 0.153647 | | | | | 13.8 |
| 19 | 33.363986 | 9.233254 | CAF2 | 1.555560 | 1.555790 | 1.555331 | 14.0 |
| 20 | −29.042761 | 0.286490 | | | | | 14.1 |
| 21 | −30.717074 | 2.499966 | LIBAF3 | 1.723779 | 1.724156 | 1.723403 | 13.9 |
| 22 | 37.605573 | 0.777247 | | | | | 14.4 |
| 23 | 41.495065 | 8.112775 | CAF2 | 1.555560 | 1.555790 | 1.555331 | 14.7 |
| 24 | −39.891458 | 0.137287 | | | | | 15.0 |
| 25 | 52.348329 | 7.483489 | CAF2 | 1.555560 | 1.555790 | 1.555331 | 14.9 |
| 26 | −38.857428 | 0.439481 | | | | | 14.6 |
| 27 | −39.387006 | 2.573963 | LIBAF3 | 1.723779 | 1.724156 | 1.723403 | 14.3 |
| 28 | 26.257462 | 1.305712 | | | | | 13.6 |
| 29 | 32.469907 | 8.214771 | CAF2 | 1.555560 | 1.555790 | 1.555331 | 13.8 |
| 30 | −37.709747 | −0.699419 | | | | | 13.9 |
| 31 | 0.000000 | 0.849241 | | | | | 13.5 |
| 32 | 20.034152 | 5.168765 | CAF2 | 1.555560 | 1.555790 | 1.555331 | 12.6 |
| 33 | 47.297907 | 0.149870 | | | | | 11.8 |
| 34 | 10.274177 | 7.072490 | CAF2 | 1.555560 | 1.555790 | 1.555331 | 9.5 |
| 35 | 20.120157 | 1.870330 | | | | | 7.6 |
| 36 | 0.000000 | 1.900000 | CAF2 | 1.555560 | 1.555790 | 1.555331 | 7.0 |
| 37 | 0.000000 | 4.400000 | | | | | 5.9 |
| 38 | 0.000000 | 0.000000 | | | | | 0.0 |

TABLE 2
(for FIG. 2)

| EBR/mm | 9 | | | | | | |
|---|---|---|---|---|---|---|---|
| GIH/mm | 0.01 | | | | | | |
| EFL/mm | 10 | | | | | | |
| WL/nm | 157.00 | 156.90 | 157.10 | | | | |
| | | | | | | | Semi- |
| Surface | Radius | Thickness | Material | n(157.00) | n(156.90) | n(157.10) | diameter |
| 0 | 0.000000 | Infinite | | | | | |
| 1 | −30.597435 | 2.499061 | LIBAF3 | 1.723779 | 1.724156 | 1.723403 | 9.1 |
| 2 | 39.139911 | 5.323505 | | | | | 9.7 |
| 3 | −56.008991 | 6.905495 | CAF2 | 1.555560 | 1.555790 | 1.555331 | 11.1 |
| 4 | −15.857167 | 6.607974 | | | | | 12.0 |
| 5 | −2813.676747 | 5.099225 | CAF2 | 1.555560 | 1.555790 | 1.555331 | 12.0 |
| 6 | −28.960949 | 1.522858 | | | | | 12.0 |
| 7 | −21.721629 | 2.499593 | LIBAF3 | 1.723779 | 1.724156 | 1.723403 | 11.9 |
| 8 | 44.778316 | 0.331566 | | | | | 12.9 |
| 9 | 41.405358 | 6.557993 | CAF2 | 1.555560 | 1.555790 | 1.555331 | 13.2 |
| 10 | −50.014705 | 0.216718 | | | | | 13.6 |
| 11 | 24.545259 | 8.526465 | CAF2 | 1.555560 | 1.555790 | 1.555331 | 14.3 |
| 12 | −66.393138 | 2.583705 | | | | | 13.8 |
| 13 | −28.363161 | 2.589064 | LIBAF3 | 1.723779 | 1.724156 | 1.723403 | 13.5 |
| 14 | 57.042390 | 0.156510 | | | | | 13.6 |
| 15 | 24.598057 | 9.742692 | CAF2 | 1.555560 | 1.555790 | 1.555331 | 14.3 |
| 16 | −38.099534 | 1.130187 | | | | | 14.0 |
| 17 | −30.928854 | 2.498845 | LIBAF3 | 1.723779 | 1.724156 | 1.723403 | 13.7 |
| 18 | 37.236704 | 0.151194 | | | | | 13.5 |
| 19 | 32.743494 | 8.661697 | CAF2 | 1.555560 | 1.555790 | 1.555331 | 13.6 |
| 20 | −30.628310 | 0.150529 | | | | | 13.6 |
| 21 | −34.170357 | 2.498636 | LIBAF3 | 1.723779 | 1.724156 | 1.723403 | 13.4 |
| 22 | 34.253661 | 0.630346 | | | | | 13.5 |
| 23 | 35.717593 | 8.133820 | CAF2 | 1.555560 | 1.555790 | 1.555331 | 13.7 |
| 24 | −34.307026 | 0.137287 | | | | | 13.8 |
| 25 | 35.634193 | 6.690353 | CAF2 | 1.555560 | 1.555790 | 1.555331 | 13.0 |
| 26 | −44.516815 | 0.844711 | | | | | 12.4 |
| 27 | −36.814414 | 2.500470 | LIBAF3 | 1.723779 | 1.724156 | 1.723403 | 12.0 |
| 28 | 19.581455 | 1.608254 | | | | | 10.8 |
| 29 | 27.877437 | 6.784942 | CAF2 | 1.555560 | 1.555790 | 1.555331 | 10.9 |
| 30 | −29.798653 | 0.576777 | | | | | 10.9 |
| 31 | 0.000000 | −0.425527 | | | | | 10.2 |
| 32 | 16.570221 | 4.581118 | CAF2 | 1.555560 | 1.555790 | 1.555331 | 9.5 |
| 33 | 60.504092 | 0.628730 | | | | | 8.6 |
| 34 | 6.996112 | 5.659676 | CAF2 | 1.555560 | 1.555790 | 1.555331 | 6.3 |
| 35 | 18.531097 | 0.891662 | | | | | 4.2 |
| 36 | 0.000000 | 1.900000 | CAF2 | 1.555560 | 1.555790 | 1.555331 | 3.4 |
| 37 | 0.000000 | 1.000000 | | | | | 2.1 |
| 38 | 0.000000 | 0.000000 | | | | | 0.0 |

TABLE 3
(for FIG. 3)

| EBR/mm | 9 | | | | | | |
|---|---|---|---|---|---|---|---|
| GIH/mm | 0.02 | | | | | | |
| EFL/mm | 10.3 | | | | | | |
| WL/nm | 157.000 | 156.900 | 157.100 | | | | |
| | | | | | | | Semi- |
| Surface | Radius | Thickness | Material | n(157.00) | n(156.90) | n(157.10) | diameter |
| 0 | 0.000000 | | | | | | |
| 1 | −41.329926 | 2.000000 | LIBAF3 | 1.723779 | 1.724156 | 1.723403 | 9.1 |
| 2 | 31.792646 | 6.321983 | | | | | 9.5 |
| 3 | −44.540929 | 5.821746 | CAF2 | 1.555560 | 1.555790 | 1.555331 | 11.1 |
| 4 | −16.073636 | 0.311803 | | | | | 11.9 |
| 5 | −1712.435226 | 5.591719 | CAF2 | 1.555560 | 1.555790 | 1.555331 | 12.2 |
| 6 | −22.407348 | 1.575598 | | | | | 12.2 |
| 7 | −22.997980 | 2.000000 | LIBAF3 | 1.723779 | 1.724156 | 1.723403 | 11.4 |
| 8 | 36.458766 | 1.410885 | | | | | 11.9 |
| 9 | 62.956751 | 5.072163 | CAF2 | 1.555560 | 1.555790 | 1.555331 | 12.1 |
| 10 | −41.990441 | 0.149392 | | | | | 12.5 |
| 11 | 20.918965 | 7.415483 | CAF2 | 1.555560 | 1.555790 | 1.555331 | 13.1 |
| 12 | −98.474092 | 3.001755 | | | | | 12.7 |
| 13 | −25.456680 | 2.000000 | LIBAF3 | 1.723779 | 1.724156 | 1.723403 | 12.4 |
| 14 | 40.959461 | 0.149737 | | | | | 12.6 |
| 15 | 27.276166 | 8.753333 | CAF2 | 1.555560 | 1.555790 | 1.555331 | 13.0 |
| 16 | −26.221606 | 0.530757 | | | | | 13.0 |
| 17 | −25.697778 | 2.000000 | LIBAF3 | 1.723779 | 1.724156 | 1.723403 | 12.7 |
| 18 | 39.291036 | 0.149586 | | | | | 13.0 |
| 19 | 24.887837 | 9.193971 | CAF2 | 1.555560 | 1.555790 | 1.555331 | 13.7 |
| 20 | −31.959028 | 1.354199 | | | | | 13.6 |
| 21 | −25.485604 | 2.000000 | LIBAF3 | 1.723779 | 1.724156 | 1.723403 | 13.4 |
| 22 | 43.061013 | 0.334680 | | | | | 14.0 |
| 23 | 40.360194 | 8.389814 | CAF2 | 1.555560 | 1.555790 | 1.555331 | 14.3 |
| 24 | −29.557374 | 0.149656 | | | | | 14.5 |
| 25 | 735.274070 | 2.000000 | LIBAF3 | 1.723779 | 1.724156 | 1.723403 | 13.9 |
| 26 | 24.293119 | 2.480534 | | | | | 13.3 |
| 27 | 45.008136 | 7.281301 | CAF2 | 1.555560 | 1.555790 | 1.555331 | 13.5 |
| 28 | −30.829826 | 0.137287 | | | | | 13.7 |
| 29 | 19.001574 | 7.307849 | CAF2 | 1.555560 | 1.555790 | 1.555331 | 12.7 |
| 30 | −149.483357 | 1.800640 | | | | | 11.9 |
| 31 | −40.080201 | 2.000000 | LIBAF3 | 1.723779 | 1.724156 | 1.723403 | 11.5 |
| 32 | 16.721465 | 1.069169 | | | | | 10.1 |
| 33 | 19.358592 | 6.970750 | CAF2 | 1.555560 | 1.555790 | 1.555331 | 10.2 |
| 34 | −25.687447 | 0.576777 | | | | | 10.0 |
| AS | 0.000000 | −0.427120 | | | | | 8.8 |
| 36 | 11.328833 | 4.666843 | CAF2 | 1.555560 | 1.555790 | 1.555331 | 7.7 |
| 37 | 30.795887 | 0.150087 | | | | | 6.3 |
| 38 | 4.760622 | 4.701510 | CAF2 | 1.555560 | 1.555790 | 1.555331 | 4.3 |
| 39 | 0.000000 | 1.002933 | PFPE | 1.370000 | 1.370000 | 1.370000 | 1.8 |
| 40 | 0.000000 | 0.000000 | | | | | 0.0 |

TABLE 4
(for FIG. 4)

| EBR/mm | 9 | | | | | | |
|---|---|---|---|---|---|---|---|
| GIH/mm | 0.02 | | | | | | |
| EFL/mm | 11.06 | | | | | | |
| WL/nm | 157.000 | 156.900 | 157.100 | | | | |
| | | | | | | | Semi- |
| Surface | Radius | Thickness | Material | n(157.00) | n(156.90) | n(157.10) | diameter |
| 0 | 0.000000 | | | | | | |
| 1 | −284.383720 | 2.000000 | LIBAF3 | 1.723779 | 1.724156 | 1.723403 | 9.3 |
| 2 | 24.567427 | 3.354922 | | | | | 9.3 |
| 3 | −48.999250 | 4.732758 | CAF2 | 1.555560 | 1.555790 | 1.555331 | 9.5 |
| 4 | −15.764981 | 0.146012 | | | | | 10.1 |
| 5 | 440.944242 | 5.022003 | CAF2 | 1.555560 | 1.555790 | 1.555331 | 10.3 |
| 6 | −19.688773 | 2.075290 | | | | | 10.3 |
| 7 | −24.056991 | 2.000000 | LIBAF3 | 1.723779 | 1.724156 | 1.723403 | 9.1 |
| 8 | 27.132650 | 1.806106 | | | | | 9.0 |
| 9 | 130.500576 | 3.704993 | CAF2 | 1.555560 | 1.555790 | 1.555331 | 9.1 |
| 10 | −32.201609 | 0.148231 | | | | | 9.4 |
| 11 | 13.871146 | 5.426822 | CAF2 | 1.555560 | 1.555790 | 1.555331 | 9.5 |
| 12 | 125.676340 | 3.208661 | | | | | 8.9 |
| 13 | −17.416301 | 2.000000 | LIBAF3 | 1.723779 | 1.724156 | 1.723403 | 8.7 |
| 14 | 62.306348 | 0.148870 | | | | | 8.8 |
| 15 | 21.165035 | 5.124180 | CAF2 | 1.555560 | 1.555790 | 1.555331 | 9.1 |
| 16 | −37.772939 | 1.674948 | | | | | 9.0 |
| 17 | −19.090326 | 2.000000 | LIBAF3 | 1.723779 | 1.724156 | 1.723403 | 8.8 |
| 18 | 39.279859 | 0.165447 | | | | | 9.3 |
| 19 | 29.880773 | 6.056294 | CAF2 | 1.555560 | 1.555790 | 1.555331 | 9.5 |
| 20 | −19.661060 | 0.158312 | | | | | 9.7 |
| 21 | −22.809696 | 2.000000 | LIBAF3 | 1.723779 | 1.724156 | 1.723403 | 9.5 |
| 22 | 36.265474 | 0.320954 | | | | | 10.0 |
| 23 | 32.003526 | 6.503760 | CAF2 | 1.555560 | 1.555790 | 1.555331 | 10.3 |
| 24 | −20.730045 | 0.146692 | | | | | 10.5 |
| 25 | −56.529303 | 2.000000 | LIBAF3 | 1.723779 | 1.724156 | 1.723403 | 10.1 |
| 26 | 21.681043 | 2.730071 | | | | | 10.1 |
| 27 | 161.683353 | 5.639081 | CAF2 | 1.555560 | 1.555790 | 1.555331 | 10.3 |
| 28 | −19.081145 | 0.137287 | | | | | 10.8 |
| 29 | 18.245247 | 6.467582 | CAF2 | 1.555560 | 1.555790 | 1.555331 | 10.8 |
| 30 | −56.459365 | 1.202698 | | | | | 10.3 |
| 31 | −32.746544 | 2.000000 | LIBAF3 | 1.723779 | 1.724156 | 1.723403 | 10.0 |
| 32 | 17.534257 | 0.911884 | | | | | 9.2 |
| 33 | 20.208090 | 6.387579 | CAF2 | 1.555560 | 1.555790 | 1.555331 | 9.3 |
| 34 | −21.003236 | 0.149035 | | | | | 9.2 |
| 35 | 11.800120 | 4.493989 | CAF2 | 1.555560 | 1.555790 | 1.555331 | 7.3 |
| 36 | 91.433466 | 0.447327 | | | | | 6.1 |
| AS | 0.000000 | −0.300000 | | | | | 5.9 |
| 38 | 4.330465 | 5.213747 | LUAG | 2.150000 | 2.150000 | 2.150000 | 3.9 |
| 39 | 0.000000 | 0.000000 | | | | | 0.0 |

TABLE 5A
(for FIG. 5)

| EBR/mm | 9 | | | | | | |
|---|---|---|---|---|---|---|---|
| GIH/mm | 0.01 | | | | | | |
| EFL/mm | 0 | | | | | | |
| WL/nm | 157.00 | 156.90 | 157.10 | | | | |
| | | | | | | | Semi- |
| Surface | Radius | Thickness | Material | n(157.00) | n(156.90) | n(157.10) | diameter |
| 0 | 0.000000 | Infinite | | | | | |
| 1 | −19.930946 | 2.000000 | CAF2 | 1.555560 | 1.555790 | 1.555331 | 9.0 |
| 2 | 28.158342 | 3.717560 | | | | | 10.1 |
| 3 | 213.885633 | 3.607739 | CAF2 | 1.555560 | 1.555790 | 1.555331 | 11.4 |
| 4 | −94.508874 | 3.127306 | | | | | 12.3 |
| 5 | 76.035122 | 5.328325 | CAF2 | 1.555560 | 1.555790 | 1.555331 | 14.8 |
| 6 | −85.721575 | 0.500000 | | | | | 15.3 |
| 7 | 0.000000 | 2.500000 | CAF2 | 1.555560 | 1.555790 | 1.555331 | 15.7 |
| 8 | 0.000000 | 0.500000 | | | | | 16.0 |
| 9 | 28.389492 | 6.761002 | CAF2 | 1.555560 | 1.555790 | 1.555331 | 15.2 |
| 10 | 686.530588 | 2.667939 | | | | | 14.4 |
| 11 | −52.737354 | 4.999300 | CAF2 | 1.555560 | 1.555790 | 1.555331 | 14.1 |
| 12 | −83.797568 | 0.149858 | | | | | 13.0 |
| 13 | 11.232023 | 5.935438 | CAF2 | 1.555560 | 1.555790 | 1.555331 | 10.0 |
| 14 | 13.323430 | 0.149774 | | | | | 8.0 |
| 15 | 7.468941 | 4.861630 | CAF2 | 1.555560 | 1.555790 | 1.555331 | 6.7 |
| 16 | 6.673910 | 0.149534 | | | | | 4.3 |
| 17 | 3.725785 | 4.284333 | CAF2 | 1.555560 | 1.555790 | 1.555331 | 3.4 |
| 18 | 0.000000 | 0.000000 | | | | | 0.0 |

TABLE 5B
(for FIG. 5)
Diffractive surface

| Face | 8 |
|---|---|
| Wavelength | 157.000 nm |
| Order of | 1.000000 |
| diffraction | |
| C2 | −9.681856E−03 |
| C4 | −2.359056E−06 |
| C6 | −1.461511E−09 |
| C8 | −1.558783E−12 |
| C10 | 2.620733E−16 |
| C12 | −3.195169E−18 |

TABLE 6A
(for FIG. 6)

| NA | 0.9 | | | | | | |
|---|---|---|---|---|---|---|---|
| GIH/mm | 0.02 | | | | | | |
| EFL/mm | 0 | | | | | | |
| WL/nm | 157.000 | 156.900 | 157.100 | | | | |
| | | | | | | | Semi- |
| Surface | Radius | Thickness | Material | n(157.00) | n(156.90 | n(157.10) | diameter |
| 0 | 0.000000 | | | | | | |
| 1 | 6538246.332700 | 3.557413 | CAF2 | 1.555560 | 1.555790 | 1.555331 | 9.2 |
| 2 | −40.344871 | 9.148357 | | | | | 9.2 |
| 3 | −99.617677 | 3.000112 | CAF2 | 1.555560 | 1.555790 | 1.555331 | 7.9 |
| 4 | 17.706483 | 14.480386 | | | | | 7.6 |
| 5 | 124.648893 | 4.148417 | CAF2 | 1.555560 | 1.555790 | 1.555331 | 10.0 |
| 6 | −41.919131 | 69.281096 | | | | | 10.2 |
| 7 | 0.000000 | 2.116418 | | | | | 9.9 |
| 8 | 20.496844 | 5.438306 | CAF2 | 1.555560 | 1.555790 | 1.555331 | 9.9 |
| 9 | −112.653466 | 14.379843 | | | | | 9.5 |
| 10 | 7.360162 | 3.366601 | CAF2 | 1.555560 | 1.555790 | 1.555331 | 3.8 |
| 11 | 26.843492 | 17.967674 | | | | | 2.7 |
| 12 | 131.794243 | 11.897595 | CAF2 | 1.555560 | 1.555790 | 1.555331 | 44.7 |
| 13 | 101.140257 | 16.972657 | | | | | 39.4 |
| 14 | 253.877331 | 12.458324 | CAF2 | 1.555560 | 1.555790 | 1.555331 | 34.7 |
| 15 | −788.273098 | −12.458324 | REFL | 1.555560 | 1.555790 | 1.555331 | 31.7 |
| 16 | 253.877331 | −16.972657 | | | | | 34.7 |
| 17 | 101.140257 | −11.897595 | CAF2 | 1.555560 | 1.555790 | 1.555331 | 39.4 |
| 18 | 131.794243 | −12.846494 | | | | | 44.7 |
| 19 | 68.171794 | 12.846494 | REFL | | | | 46.0 |
| 20 | 131.794243 | 11.897595 | CAF2 | 1.555560 | 1.555790 | 1.555331 | 44.7 |
| 21 | 101.140257 | 16.972657 | | | | | 39.4 |
| 22 | 253.877331 | 12.458324 | CAF2 | 1.555560 | 1.555790 | 1.555331 | 34.7 |
| 23 | −788.273098 | 2.000000 | | | | | 31.7 |
| 24 | 0.000000 | 0.000000 | | | | | 0.0 |

TABLE 6B
(for FIG. 6)

| Face | 14 | 16 | 22 |
|---|---|---|---|
| K | 0 | 0 | 0 |
| C1 | −4.17E−07 | −4.17E−07 | −4.17E−07 |
| C2 | 3.45E−11 | 3.45E−11 | 3.45E−11 |
| C3 | 2.77E−14 | 2.77E−14 | 2.77E−14 |
| C4 | −5.99E−17 | −5.99E−17 | −5.99E−17 |
| C5 | 4.52E−20 | 4.52E−20 | 4.52E−20 |
| C6 | −1.59E−23 | −1.59E−23 | −1.59E−23 |

TABLE 7
(for FIG. 7)

| NA | 1.16 | | | | | | |
|---|---|---|---|---|---|---|---|
| GIH/mm | 0.02 | | | | | | |
| EFL/mm | 0 | | | | | | |
| WL/nm | 157.000 | 156.900 | 157.100 | | | | |
| | | | | | | | Semi- |
| Surface | Radius | Thickness | Material | n(157.00 | n(156.90 | n(157.10 | diameter |
| 0 | 0.000000 | | | | | | |
| 1 | −902816.150710 | 4.875877 | CAF2 | 1.555560 | 1.555790 | 1.555331 | 9.1 |
| 2 | −18.555799 | 0.923739 | | | | | 9.1 |
| 3 | −17.601439 | 2.491895 | CAF2 | 1.555560 | 1.555790 | 1.555331 | 8.7 |
| 4 | 20.330620 | 2.683454 | | | | | 8.7 |
| 5 | 143.225716 | 5.266154 | CAF2 | 1.555560 | 1.555790 | 1.555331 | 9.0 |
| 6 | −19.188968 | 0.607830 | | | | | 9.4 |
| 7 | 83.147635 | 2.499841 | CAF2 | 1.555560 | 1.555790 | 1.555331 | 9.3 |
| 8 | 21.568567 | 6.513344 | | | | | 9.0 |
| 9 | −13.407597 | 2.498855 | CAF2 | 1.555560 | 1.555790 | 1.555331 | 9.1 |
| 10 | −22.764037 | 0.199775 | | | | | 10.5 |
| 11 | 47.017889 | 5.189768 | CAF2 | 1.555560 | 1.555790 | 1.555331 | 11.9 |
| 12 | −63.396016 | 0.199922 | | | | | 12.1 |
| 13 | 30.555963 | 6.355425 | CAF2 | 1.555560 | 1.555790 | 1.555331 | 12.3 |
| 14 | −57.099196 | 1.768814 | | | | | 12.0 |
| 15 | −34.216745 | 2.497722 | CAF2 | 1.555560 | 1.555790 | 1.555331 | 11.7 |
| 16 | −138.744152 | 12.017185 | | | | | 11.4 |
| 17 | 0.000000 | 5.126214 | | | | | 9.5 |
| 18 | 73.344694 | 3.160086 | CAF2 | 1.555560 | 1.555790 | 1.555331 | 8.7 |
| 19 | −235.992261 | 8.981997 | | | | | 8.4 |
| 20 | 11.522791 | 2.498965 | CAF2 | 1.555560 | 1.555790 | 1.555331 | 5.9 |
| 21 | 6.922769 | 1.489370 | | | | | 4.8 |
| 22 | 8.332468 | 4.559191 | CAF2 | 1.555560 | 1.555790 | 1.555331 | 4.8 |
| 23 | −13.594989 | 1.135979 | | | | | 4.1 |
| 24 | −9.681255 | 2.602066 | CAF2 | 1.555560 | 1.555790 | 1.555331 | 3.0 |
| 25 | −10.133616 | 30.144095 | | | | | 2.3 |
| 26 | 142.331552 | 5.584651 | CAF2 | 1.555560 | 1.555790 | 1.555331 | 42.0 |
| 27 | 128.443341 | 14.058243 | | | | | 39.0 |
| 28 | 0.000000 | 5.000000 | CAF2 | 1.555560 | 1.555790 | 1.555331 | 33.4 |
| 29 | 0.000000 | −5.000000 | REFL | 1.555560 | 1.555790 | 1.555331 | 31.4 |
| 30 | 0.000000 | −14.058243 | | | | | 33.4 |
| 31 | 128.443341 | −5.584651 | CAF2 | 1.555560 | 1.555790 | 1.555331 | 39.0 |
| 32 | 142.331552 | −16.745882 | | | | | 42.0 |
| 33 | 53.912558 | 16.745882 | REFL | | | | 43.1 |
| 34 | 142.331552 | 5.584651 | CAF2 | 1.555560 | 1.555790 | 1.555331 | 42.0 |
| 35 | 128.443341 | 12.058243 | | | | | 39.0 |
| 36 | 33.122282 | 7.000000 | CAF2 | 1.555560 | 1.555790 | 1.555331 | 9.5 |
| 37 | 0.000000 | 2.000000 | PFPE | 1.370000 | 1.370000 | 1.370000 | 31.4 |
| 38 | 0 | 0 | | | | | 0.017 |

TABLE 8
(for FIG. 8)

| EBR/mm | 9 | | | | | | |
|---|---|---|---|---|---|---|---|
| GIH/mm | 0.01 | | | | | | |
| EFL/mm | 10 | | | | | | |
| WL/nm | 193.37 | 193.12 | 193.62 | | | | |
| | | | | | | | Semi- |
| Surface | Radius | Thickness | Material | n(193.37) | n(193.12) | n(193.62) | diameter |
| 0 | 0.000000 | Infinite | | | | | |
| 1 | −115.268637 | 1.699338 | SiO2 | 1.560323 | 1.560718 | 1.559930 | 9.0 |
| 2 | 21.244556 | 2.375809 | | | | | 9.1 |
| 3 | 66.442138 | 6.385864 | CaF2 | 1.501373 | 1.501619 | 1.501128 | 9.5 |
| 4 | −15.754877 | 0.149869 | | | | | 9.9 |
| 5 | −19.695915 | 1.919897 | SiO2 | 1.560323 | 1.560718 | 1.559930 | 9.8 |
| 6 | 39.511023 | 1.314945 | | | | | 10.5 |
| 7 | 79.901033 | 7.820745 | CaF2 | 1.501373 | 1.501619 | 1.501128 | 10.7 |
| 8 | −32.118403 | 0.149911 | | | | | 11.6 |
| 9 | 19.406352 | 6.871488 | CaF2 | 1.501373 | 1.501619 | 1.501128 | 12.3 |
| 10 | −2297.600412 | 3.978375 | | | | | 11.8 |
| 11 | −22.213221 | 2.149318 | SiO2 | 1.560323 | 1.560718 | 1.559930 | 11.5 |
| 12 | 34.716980 | 0.149416 | | | | | 11.9 |
| 13 | 21.058494 | 9.776110 | CaF2 | 1.501373 | 1.501619 | 1.501128 | 12.5 |
| 14 | −27.182521 | 0.733377 | | | | | 12.3 |
| 15 | −24.782450 | 2.168846 | SiO2 | 1.560323 | 1.560718 | 1.559930 | 12.1 |
| 16 | 21.937665 | 2.819607 | | | | | 11.8 |
| 17 | 48.370641 | 8.241824 | CaF2 | 1.501373 | 1.501619 | 1.501128 | 12.1 |
| 18 | −21.053862 | −1.565140 | | | | | 12.5 |
| 19 | 0.000000 | 2.290214 | | | | | 12.1 |
| 20 | 18.432951 | 4.488716 | CaF2 | 1.501373 | 1.501619 | 1.501128 | 11.1 |
| 21 | 47.374694 | 0.149620 | | | | | 10.5 |
| 22 | 11.551836 | 4.586976 | CaF2 | 1.501373 | 1.501619 | 1.501128 | 9.1 |
| 23 | 19.526304 | 0.148825 | | | | | 7.9 |
| 24 | 8.675772 | 4.707684 | CaF2 | 1.501373 | 1.501619 | 1.501128 | 6.7 |
| 25 | 37.156479 | 0.754817 | | | | | 5.0 |
| 26 | 0.000000 | 4.379774 | SiO2 | 1.560323 | 1.560718 | 1.559930 | 4.1 |
| 27 | 0.000000 | 0.500000 | | | | | 1.0 |
| 28 | 0.000000 | 0.000000 | | | | | 0.0 |

Even though the invention has also been described on the basis of specific embodiments, numerous variations and alternative embodiments will be apparent to a person skilled in the art, for example by combining and/or exchanging features of individual embodiments. Accordingly, it goes without saying for a person skilled in the art that such variations and alternative embodiments are also encompassed by the present invention, and the scope of the invention is restricted only within the meaning of the accompanying patent claims and the equivalents thereof.

What is claimed is:

1. A microscope objective, in particular for a device for determining the position of structures on a mask for microlithography, having a first number of converging lenses made of a first material and a second number of diverging lenses made of a second material, with the microscope objective being designed for an operating wavelength (A) below 190 nm and with the following relationship
$$A = \frac{NA}{\frac{{v}_{1}}{{v}_{2}} - 1} > 2.5$$
applying, where NA denotes the object-side numerical aperture of the microscope objective, v₁ denotes the Abbe number of the first material and v₂ denotes the Abbe number of the second material.

2. The microscope objective according to claim 1, wherein A is greater than 2.8, in particular greater than 3.0 and more particularly greater than 3.2.

3. The microscope objective according to claim 1, wherein the ratio v₁/v₂ has a value of less than 1.4, in particular less than 1.3.

4. The microscope objective according to claim 1, wherein the microscope objective is designed for an operating wavelength (λ) below 180 nm, in particular below 170 nm and more particularly below 160 nm.

5. The microscope objective according to claim 1, wherein the first number and the second number are both greater than seven, in particular greater than eight.

6. The microscope objective according to claim 1, wherein the relationship N>λ/0.22, in particular N>λ/0.20 and more particularly N>λ/0.18 applies, where N is the total number of lenses of the microscope objective.

7. The microscope objective according to claim 1, wherein the object-side numerical aperture (NA) of the microscope objective is at least 0.6, in particular at least 0.85, more particularly at least 0.9, more particularly at least 1.0 and more particularly at least 1.1.

8. The microscope objective according to claim 1, wherein the second material is selected from the group containing lithium barium fluoride (LiBaF₃), lithium fluoride (LiF) and sodium chloride (NaCl).

9. The microscope objective according to claim 1, wherein the first material is calcium fluoride (CaF₂).

10. The microscope objective according to claim 1, wherein the converging lenses and the diverging lenses form an alternating arrangement.

11. The microscope objective according to claim 1, wherein said microscope objective comprises an aperture stop (AS) arranged in a stop plane, with the ratio B=d₁/d₂ for this stop plane being greater than four, in particular greater than five, where d₂ denotes the distance between the stop plane and the object plane and d₁ denotes the overall length of the microscope objective.

12. The microscope objective according to claim 1, wherein an image contrast obtained when operating the microscope objective using light with a bandwidth greater than 2 pm, in particular greater than 5 pm, more particularly greater than 10 pm and more particularly greater than 20 pm is reduced by no more than 10% in comparison with the use of light from an ideal monochromatic light source.

13. A microscope objective, in particular for a device for determining the position of structures on a mask for microlithography,
wherein the microscope objective is designed for an operating wavelength (λ) below 190 nm,
wherein the object-side numerical aperture (NA) of the microscope objective is at least 0.6,
wherein the microscope objective comprises a mirror for at least partial correction of chromatic aberrations, and
wherein an image contrast obtained when operating the microscope objective using light with a bandwidth greater than 2 pm is reduced by no more than 10% in comparison with the use of light from an ideal monochromatic light source.

14. The microscope objective according to claim 13, wherein an image contrast obtained when operating the microscope objective using light with a bandwidth greater than 5 pm, in particular greater than 10 pm and more particularly greater than 20 pm is reduced by no more than 10% in comparison with the use of light from an ideal monochromatic light source.

15. The microscope objective according to claim 13, wherein the microscope objective is designed for an operating wavelength (λ) below 180 nm, in particular below 170 nm and more particularly below 160 nm.

16. The microscope objective according to claim 1, wherein said microscope objective has an immersion medium between the last lens on the object plane side and the object plane (OP), said immersion medium having a refractive index of at least 1.3 at the operating wavelength (λ).

17. The microscope objective according to claim 16, wherein the immersion medium is perfluoropolyether (PFPE).

18. The microscope objective according to claim 1, wherein said microscope objective comprises a last lens on the object plane side made of a material which has a refractive index of at least 1.8, in particular at least 2.0, at the operating wavelength.

19. The microscope objective according to claim 1, wherein between a last optical surface of the microscope objective on the object plane side and the object plane there is a distance of less than λ, in particular less than λ/2 and more particularly less than λ/5.

20. The microscope objective according to claim 1, wherein said microscope objective comprises a diffractive optical element (DOE) for at least partial correction of chromatic aberrations, in particular of the longitudinal chromatic aberration.

21. A microscope objective, in particular for a device for determining the position of structures on a mask for microlithography,
wherein the microscope objective is designed for an operating wavelength (λ) below 190 nm,
wherein the object-side numerical aperture (NA) of the microscope objective is at least 0.6,
wherein the microscope objective comprises a diffractive optical element (DOE) for at least partial correction of chromatic aberrations, and
wherein an image contrast obtained when operating the microscope objective using light with a bandwidth greater than 2 pm is reduced by no more than 10% in comparison with the use of light from an ideal monochromatic light source.

22. The microscope objective according to claim 21, wherein an image contrast obtained when operating the microscope objective using light with a bandwidth greater than 5 pm, in particular greater than 10 pm and more particularly greater than 20 pm is reduced by no more than 10% in comparison with the use of light from an ideal monochromatic light source.

23. The microscope objective according to claim 21, wherein it exclusively comprises a single optical material.

24. The microscope objective according to claim 21, wherein the microscope objective is designed for an operating wavelength (λ) below 180 nm, in particular below 170 nm and more particularly below 160 nm.

25. A device for determining the position of structures on a mask for microlithography, wherein the device comprises a microscope objective according to claim 1.
